(19) United States
(12) Patent Application Publication
(10) Pub. No.: US 2019/0376627 A1
(43) Pub. Date: Dec. 12, 2019

(54) RESPONSIVE GIB SUPPORT STRUCTURE

(71) Applicant: Hyosung Heavy Industries Corporation, Seoul (KR)

(72) Inventors: Sung Ho LEE, Changwon-si, Gyeongsangnam-do (KR); Young Jun JEON, Gimhae-si, Gyeongsangnam-do (KR)

(21) Appl. No.: 16/472,292

(22) PCT Filed: Dec. 11, 2017
(86) PCT No.: PCT/KR2017/014461

§ 371 Date: Jun. 21, 2019

(30) Foreign Application Priority Data
Dec. 21, 2016 (KR) 10-2016-0176085

(51) Int. Cl. F16L 3/18; F16L 23/00

(52) U.S. Cl. CPC F16L 3/18; F16L 23/006

(57) ABSTRACT

The present invention relates to a responsive gas insulated bus (GIB) support structure. The responsive GIB support structure includes: a support; a speed-responsive unlocking unit provided in an upper portion of the support so that a guide is exposed on two sides of the speed-responsive unlocking unit; and a bracket provided to a flange of the tank, wherein the guide is coupled to the bracket. Accordingly, in the present invention, when a variation in pressure and a change in length due to heat occur, the unlocked state of the speed-responsive unlocking unit is maintained when the deformation amount is large or slow through the speed-responsive unlocking unit supporting the structural object, so that it is possible to prevent deformation and breakage of the structural object.

### TECHNICAL FIELD

The present invention relates to a gas insulated bus (GIB) support structure, and more particularly, to allow a GIB support structure to resist deformation in a case where the deformation occurs due to various factors such as thermal expansion/contraction, internal pressure, seismic load, a case where a deformation amount is large and a deformation speed is low in order to actively control, and a case where there is no affect and the deformation speed is high.

### BACKGROUND ART

In general, in a structural object having a shape of a pipe or a tank extending in the longitudinal direction, a bracket or a support is used as a means for stably fixing the structural object to a floor or a wall while facilitating construction.

In order to support a sufficient load of the structural object, the support for supporting the structural object includes a lower plate having a through hole formed on the top of the concrete in which anchor bolts are buried, a spacer member having a predetermined height above the lower plate, and an upper plate coupled to the structural object at an upper portion of the spacer member with bolts.

According to the form in which the upper plate is coupled to the spacer member, that is, in a case where the upper plate is fixed to the spacer member by welding or with bolts, a fixing type support is used, and in a case where the upper plate can be glidingly moved in the longitudinal direction of the structural object with respect to the spacer member, a sliding type support is used.

When various factors such as thermal expansion/contraction, internal pressure, or seismic load are applied to the structural object in the longitudinal direction of the structural object, the support cannot sufficiently absorb the deformation, and thus, there is a problem in that the structural object is deformed and broken. In order to solve such a problem, a bellows, which is stretchably provided in a cut-out portion formed by cutting out a portion of the structural object, is provided so as to absorb the deformation of the structural object.

However, such a support has a problem in that, in a case where deformation is generated due to due to various factors such as thermal expansion/contraction, internal pressure, or seismic load, the support cannot adequately resist the deformation depending on a deformation amount and a deformation speed. That is, for the case of an earthquake where the deformation amount is large and the deformation speed is high and for the case of thermal expansion/contraction where the deformation amount is small or the deformation speed is slow, the support resists the deformation by the same process, and thus, there is a problem in that the stability of the structural object is lowered.

### SUMMARY OF INVENTION

### Technical Problem

In the present invention, in a case where thermal expansion/contraction, internal pressure, and seismic load from the outside is applied to a structural object in a state where the structural object is stably supported through the support, the structural object is allowed to be actively supported according to magnitude and speed of the applied load, so as to prevent deformation and breakage of the structural object, to further improve stability of the structural object, and to increase life time of the structural object.

### Solution to Problem

According to an aspect of the present invention, there is provided a responsive GIB support structure including: a support; a speed-responsive unlocking unit provided in an upper portion of the support so that a guide is exposed on two sides of the speed-responsive unlocking unit; and a bracket provided to a flange of the tank, wherein the guide is coupled to the bracket.

In the above aspect, the speed-responsive unlocking unit includes unitary unlocking units in an unlocking body, wherein the unitary unlocking unit includes: a unitary unlocking body having a guide through hole; a spring mounting hole formed in the unitary unlocking body to be connected to the guide through hole; an unlocking member mounting hole formed in the unitary unlocking body to be connected to the spring mounting hole; a spring mounted in the spring mounting hole; and an unlocking member mounted in the unlocking member mounting hole and configured to be applied with an elastic force of the spring, and wherein the guide passes through the guide through holes, the springs, and the unlocking members to be exposed to an outside.

In the above aspect, the unlocking body is divided into upper and lower unitary unlocking bodies, and the upper unitary unlocking bodies are detachably coupled to each other with bolts.

In the above aspect, the unlocking member mounting hole is provided with an outer tapered portion of which sectional area is gradually decreased toward the spring mounting hole.

In the above aspect, a guide protrusion is formed in the outer tapered portion in an axial direction.

In the above aspect, the unlocking member has an inner tapered portion of which sectional area on the outer peripheral edge side is gradually decreased toward the spring mounting hole and a guide contact portion of which cross-section on the inner peripheral edge side has a certain shape.

In the above aspect, the inner tapered portion has a guide groove formed on the outer peripheral edge side in an axial direction.

In the above aspect, the unlocking member is formed to be divided into at least two portions.

In the above aspect, the unitary unlocking units are formed inside the unlocking body so as to be symmetrical on two sides of the unlocking body

In the above aspect, the bracket includes: flange pressing pieces having through holes of which centers are coincident with centers of flange holes of the flange; spacing retaining pieces formed in a horizontal direction to be bent under the flange pressing pieces; and fixing pieces having guide holes formed ends of the spacing retaining pieces, wherein the flange pressing pieces are coupled to two sides of the flange with bolts, and the speed-responsive unlocking unit is provided in an inner side between the fixing piece, and the guide is fitted into the guide holes formed in the fixing pieces.

### Advantageous Effects of Invention

In the present invention, in a case where a length of a structural object is changed due to a change of pressure and heat occur in a structural object, a speed-responsive unlocking unit supporting the structural object is actively used, that is, when a deformation amount is large or a deformation speed is low, an unlocked state of the speed-responsive unlocking unit is maintained, and thus, the deformation amount is sufficiently absorbed, so that it is possible to obtain an effect of preventing the deformation and breakage of the structural object.

In addition, in a case where seismic load is applied to the structural object, and thus, the deformation speed is high, an instantaneously locked state of the speed-responsive unlocking unit is maintained due to the deformation speed so that it is possible to obtain an effect of preventing the deformation and breakage of the structural object caused by the severe shaking of the structural object.

In addition, accordingly, it is possible to further improve the stability of the structural object.

In addition, accordingly, it is possible to obtain the effect of minimizing personal damage and material damage due to the deformation and breakage of the structural object.

### BRIEF DESCRIPTION OF DRAWINGS

FIG. 1 is a perspective view illustrating a state in which a tank, which is a structural object, is supported by a responsive GIB (Gas Insulated Bus) support structure according to the present invention.

FIG. 2 is an exploded perspective view illustrating the state in which the tank is supported by the responsive GIB support structure according to the present invention. FIG. 3 is a perspective bottom view illustrating the state in which the tank is supported by the responsive GIB support structure according to the present invention.

FIGS. 4a and 4b are enlarged longitudinal cross-sectional views illustrating the responsive GIB support structure according to the present invention before and after operation.

FIG. 5 is an enlarged longitudinal cross-sectional view illustrating the state in which the tank is supported by the responsive GIB support structure according to the present invention when viewed from another direction.

### DESCRIPTION OF EMBODIMENTS

Hereinafter, specific embodiments for carrying out the present invention will be described with reference to the accompanying drawings.

In describing the invention, the terms first, second, and the like may be used to describe various components, but the components may not be limited by the terms.

The terms are used only for the purpose of distinguishing one component from the others. For example, without departing from the scope of the present invention, a first component may be referred to as a second component, and similarly, a second component may also be referred to as a first component.

In a case where a component is referred to as being connected to or coupled with another component, the component may be directly connected to or coupled with another component, but it may be understood that still another component may exist between the components.

The terms used herein are used for the purpose of describing particular embodiments only and are not intended to limit the invention. The singular expressions may include plural expressions unless the context clearly denotes otherwise.

It is to be understood that, in the present specification, the terms “comprising”, “including”, and the like are intended to specify the presence of features, numbers, steps, operations, elements, components, or combinations thereof described in the specification, but the terms do not preclude the presence or addition of one or more other features, numbers, steps, operations, elements, components, or combinations thereof.

In addition, shapes and sizes the elements in the drawings may be exaggerated for clarity.

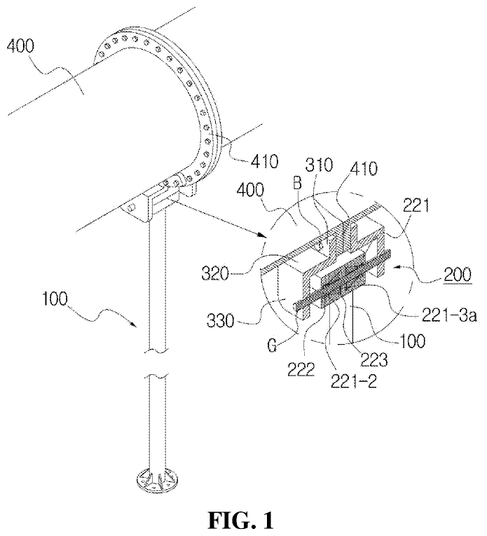

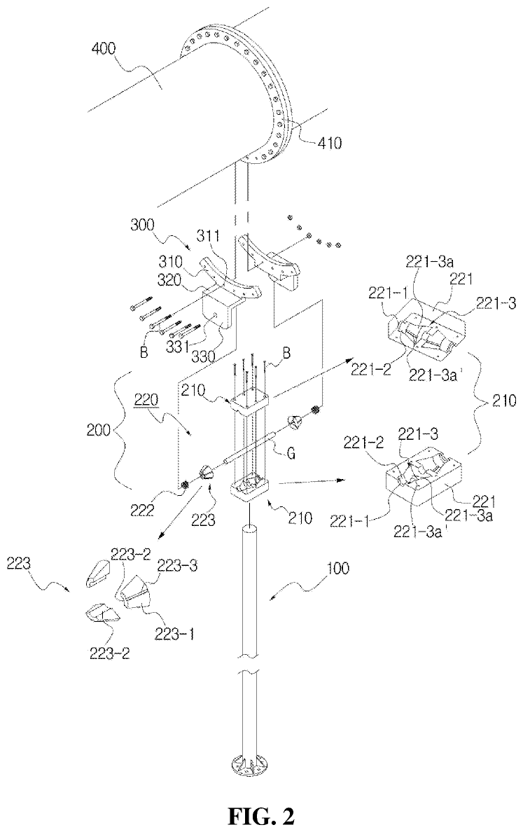

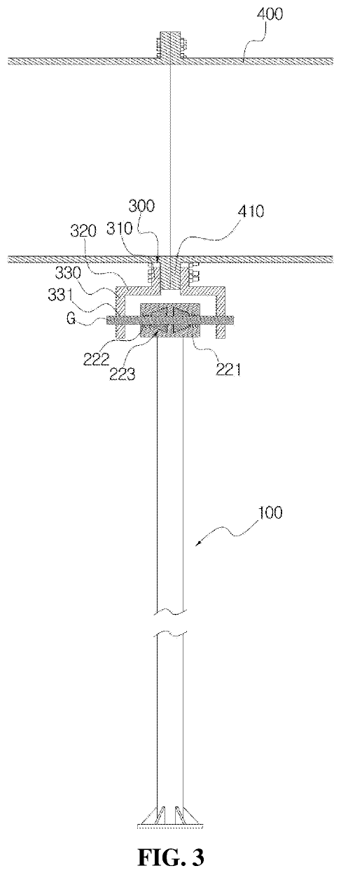

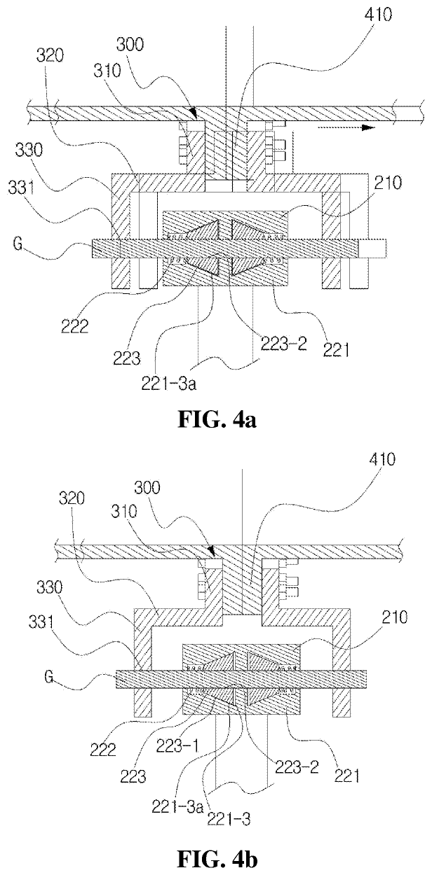

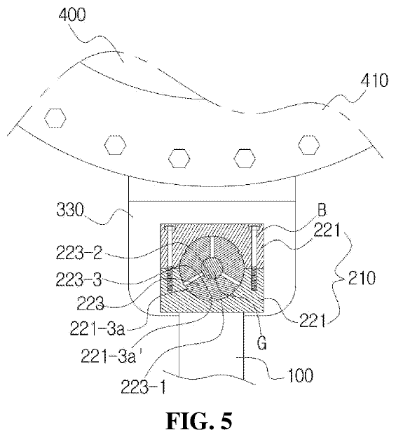

FIG. 1 is a perspective view illustrating a state in which a tank, which is a structural object, is supported by a responsive GIB (Gas Insulated Bus) support structure according to the present invention. FIG. 2 is an exploded perspective view illustrating the state in which the tank is supported by the responsive GIB support structure according to the present invention. FIG. 3 is a perspective bottom view illustrating the state in which the tank is supported by the responsive GIB support structure according to the present invention. FIGS. 4a and 4b are enlarged longitudinal cross-sectional views illustrating the responsive GIB support structure according to the present invention before and after operation. FIG. 5 is an enlarged longitudinal cross-sectional view illustrating the state in which the tank is supported by the responsive GIB support structure according to the present invention when viewed from another direction.

In a case where a length of a structural object is changed and seismic load is applied to a structural object due to a change of pressure and heat, a responsive GIB support structure according to the present invention actively supports the structural object according to a deformation amount and a deformation speed, so that it is possible to to improve stability. As illustrated in FIGS. 1 to 5, a tank 400 as a structural object can be stably supported by a support 100, a speed-responsive unlocking unit 200, and a bracket 300.

Herein, the support 100 allows the tank 400 to be spaced apart from the bottom with a certain distance, and the tank 400 can have a horizontal or sloped shape in accordance with the application. A flange is formed in the lower portion of the support 100, and the support can be easily coupled to the base by using anchor bolts (not illustrated). The speed-responsive unlocking unit 200 is provided in the upper portion of the support 100 and has a shape where a guide G is exposed on two sides. The guide G is moved or restricted to be moved in the axial direction according to the load and deformation amount applied to the structural object, so that it is possible to actively cope with the load and the deformation amount.

The speed-responsive unlocking unit 200 can restrict the movement of the guide G by the unitary unlocking unit 220 provided inside the unlocking body 210. At this time, the unlocking body 210 is divided into upper and lower unitary unlocking bodies 221, and the unitary unlocking bodies 221 are detachably connected to each other with bolts B. Therefore, the unlocking body 210 can be easily coupled or extracted in a state where the guide G is fitted into springs 222 and unlocking members 223 described later. If the unitary unlocking bodies 221 is integrally formed, the coupling of the springs 222 and the unlocking members 223 provided inside the unlocking body 210 may be difficult, or the coupling may be impossible.

In the unitary unlocking unit 220, a guide through hole 221-1 for allowing the guide G to be moved, that is, to be pulled in, drawn out, or glidingly moved in the axial direction is formed in the unitary unlocking body 221. A spring mounting hole 221-2 for mounting a spring 222 for pressing a later-described unlocking member 223 in the axial direction is formed in the unitary unlocking body 221 to be continuous to the guide through hole 221-1.

An unlocking member mounting hole 221-3 is formed in the unitary unlocking body 221 to be continuous to the spring mounting hole 221-2. A spring 222 is configured so as to be mounted in the spring mounting hole 221-2. In the unlocking member mounting hole 221-3, an outer tapered portion 221-3a of which sectional area is gradually decreased toward the spring mounting hole 221-2, so that the outer tapered portion 221-3a presses an inner tapered portion 223-1 of the later-described unlocking member 223, and at the same time, a guide contact portion 223-2 of the unlocking member 223 presses the surface of the guide G. Therefore, the state where the tank 400 as a structural object is directly coupled is maintained, so that it is possible to prevent the movement of the tank 400.

In a case where the outer tapered portion 221-3a of the spring mounting hole 221-2 presses the inner tapered portion 223-1 of the unlocking member 223, that is, in a case where the movement occurs in such a direction that the diameter or the gradient of the outer tapered portion 221-3a is increased, the inner tapered portion 223-1 of the unlocking member 223 is pressed.

On the other hand, in a case where the movement occurs in such a direction that the diameter or the gradient of the outer tapered portion 221-3a is decreased, the state where the inner tapered portion 223-1 of the unlocking member 223 is in simple contact with or spaced away from guide G is maintained by the elastic force of the spring 222, so that the tank 400 as a structural object can be moved in the longitudinal direction by the sliding movement of the guide G.

A guide protrusion 221-3a′ having an axial direction is formed in the outer tapered portion 221-3a, and a guide groove 223-3 formed in the axial direction on the outer peripheral edge side of the inner tapered portion 223-1 is coupled thereto. Therefore, it is possible to prevent the unlocking member 223 from being eccentrically moved from one side to the other on the outer peripheral edge of the unlocking member mounting hole 221-3 and the guide G.

In the unlocking member 223, the inner tapered portion 223-1 of which sectional area of the outer peripheral edge side is gradually decreased toward the spring mounting hole 221-2 is formed, and the guide contact portion 223-2 of which cross section on the inner peripheral edge side has a certain shape is formed. In the inner tapered portion 223-1, a guide groove 223-3 is formed in the axial direction on the outer peripheral edge side thereof, so that the guide protrusion 221-3a′ formed in the outer tapered portion 221-3a can be fitted into the guide groove.

In a case where the unlocking member 223 is configured to be divided into at least two or more portion to be pressed due to the gradient of the outer tapered portion 221-3a, as the diameter is decreased, the surface of the guide G can be pressed.

The unlocking member 223 to which an elastic force of the spring 222 is applied is mounted in the unlocking member mounting hole 221-3. The guide G passes through the guide through holes 221-1, the springs 222 and the unlocking members 223 to be exposed to the outside.

In the present invention, the example where the unitary unlocking unit 220 is provided on one inner side of the unlocking body 210 is described. However, besides the above configuration, the unitary unlocking unit 220 may be provided symmetrically on both sides. With this configuration, it is possible to stably resist the fluctuation of the pressure acting from both sides, the change of the length caused by heat, and the seismic load.

The guide G is coupled to the bracket 300 provided on the flange 410 of the tank 400.

The bracket 300 includes: spacing retaining pieces 320 formed in the horizontal direction to be bent under the flange pressing pieces 310 having through holes 311 of which centers are coincident with the centers of the flange holes 412 of the flange 410; and fixing pieces 330 having guide holes 331 formed at ends of the spacing retaining pieces 320.

The flange pressing pieces 310 are coupled to the two sides of the flange 410 with bolts B. The speed-responsive unlocking unit 200 is provided in the inner space between the fixing pieces 330. The guide G is fitted into the guide holes 331 formed in the fixing pieces 333.

In the responsive GIB support structure, in a state where the tank 400 as a structural object is supported, the guide G is coupled so as to be exposed on the two sides of the unlocking body 210 between the fixing pieces 330 of the bracket 300. As illustrated in FIG. 4a, in a case where there is no fluctuation of the pressure from the interval portion of the tank 400, there is no fluctuation of the length caused by heat, or there is applied no supporting load, the elastic force of the spring 222 causes the unlocking member 223 to be retained in a state where the unlocking member 223 is pressed in the direction of increasing the gradient of the outer tapered portion 221-3a, so that a state where the guide contact portion 223-2 of the unlocking member 223 is in simple contact with or spaced away from the surface of the guide G is maintained.

In addition, in a case where there is a fluctuation of the pressure or there is a fluctuation of the length caused by heat, the flange 410 moves in the longitudinal direction of the tank 400, and at the same time, the guide G is glidingly moved in the axial direction as illustrated by the one-dot dashed line, so that it is possible to prevent the tank 400 as a structural object from being deformed or broken.

On the other hand, as illustrated in FIG. 4b, in a case where a seismic load from the outside is applied to the structural object, that is, in a case where the deformation speed is high, due to the seismic load, the outer tapered portion 221-3a formed in the unlocking member mounting hole 221-3 of the unitary unlocking body 221 presses the inner tapered portion 223-1 of the unlocking member 223, and at the same time, the guide contact portion 223-2 of the unlocking member 223 presses the surface of the guide G, so that the state where the structural object is directly coupled to the tank 400 is maintained, and it is possible to prevent the movement of the tank 400.

It should be noted that the above-described embodiments are for the purpose of description and are not intended for limitation thereof. In addition, it will be understood by the ordinarily skilled in the art that various embodiments are possible within the scope of the technical idea of the present invention.

### INDUSTRIAL APPLICABILITY

The present invention relating to a gas insulated bus (GIB) support structure is applicable to a structural object construction field.

### REFERENCE SIGNS LIST

100: support

200: speed-responsive unlocking unit

210: unlocking body

220: unitary unlocking unit

221: unitary unlocking body

221-1: guide through hole

221-2: spring mounting hole

221-3: unlocking member mounting hole

222: spring

223: unlocking member

300: bracket

310: flange pressing piece

320: spacing retaining piece

330: fixing piece

400: tank

410: flange

G: guide

1. A responsive GIB support structure comprising:
a support;
a speed-responsive unlocking unit provided in an upper portion of the support so that a guide is exposed on two sides of the speed-responsive unlocking unit; and
a bracket provided to a flange of the tank,
wherein the guide is coupled to the bracket.

2. The responsive GIB support structure according to claim 1,
wherein the speed-responsive unlocking unit includes unitary unlocking units in an unlocking body,
wherein the unitary unlocking unit includes:
a unitary unlocking body having a guide through hole;
a spring mounting hole formed in the unitary unlocking body to be connected to the guide through hole;
an unlocking member mounting hole formed in the unitary unlocking body to be connected to the spring mounting hole;
a spring mounted in the spring mounting hole; and
an unlocking member mounted in the unlocking member mounting hole and configured to be applied with an elastic force of the spring, and
wherein the guide passes through the guide through holes, the springs, and the unlocking members to be exposed to an outside.

3. The responsive GIB support structure according to claim 2, wherein the unlocking body is divided into upper and lower unitary unlocking bodies, and the upper unitary unlocking bodies are detachably coupled to each other with bolts.

4. The responsive GIB support structure according to claim 2, wherein the unlocking member mounting hole is provided with an outer tapered portion of which sectional area is gradually decreased toward the spring mounting hole.

5. The responsive GIB support structure according to claim 4, wherein a guide protrusion is formed in the outer tapered portion in an axial direction.

6. The responsive GIB support structure according to claim 2, wherein the unlocking member has an inner tapered portion of which sectional area on an outer peripheral edge side is gradually decreased toward the spring mounting hole and a guide contact portion of which cross-section on the inner peripheral edge side has a certain shape.

7. The responsive GIB support structure according to claim 6, wherein the inner tapered portion has a guide groove formed on the outer peripheral edge side in an axial direction.

8. The responsive GIB support structure according to claim 6, wherein the unlocking member is formed to be divided into at least two portions.

9. The responsive GIB support structure according to claim 2, wherein the unitary unlocking units are formed inside the unlocking body so as to be symmetrical on two sides of the unlocking body.

10. The responsive GIB support structure according to claim 1,
wherein the bracket includes:
flange pressing pieces having through holes of which centers are coincident with centers of flange holes of the flange;
spacing retaining pieces formed in a horizontal direction to be bent under the flange pressing pieces; and
fixing pieces having guide holes formed ends of the spacing retaining pieces, and
wherein the flange pressing pieces are coupled to two sides of the flange with bolts, and the speed-responsive unlocking unit is provided in an inner side between the fixing piece, and the guide is fitted into the guide holes formed in the fixing pieces.
